(19) United States
(12) Patent Application Publication
(10) Pub. No.: US 2011/0021956 A1
(43) Pub. Date: Jan. 27, 2011

(54) EXERCISE ASSISTING DEVICE

(76) Inventors: Youichi Shinomiya, Ibaraki-shi (JP); Takahisa Ozawa, Katano-shi (JP); Takao Gotou, Hirakata-shi (JP); Kazuhiro Ochi, Osaka-shi (JP); Naoto Shirasawa, Kyoto-shi (JP); Masaki Nagano, Ibaraki-shi (JP)

Correspondence Address: Cheng Law Group, PLLC, 1100 17th Street, N.W., Suite 503, Washington, DC, 20036, US

(21) Appl. No.: 12/934,653

(22) PCT Filed: Mar. 31, 2008
(86) PCT No.: PCT/JP2008/056440

§ 371 Date: Sep. 26, 2010

(51) Int. Cl. A61H 1/00

(52) U.S. Cl. 601/5

(57) ABSTRACT

An exercise assisting device comprises steps, a step driving means, and a movable range variation means. The steps are provided for bearing the user's feet, respectively. The step driving means is configured to move the steps so as to provide the exercise to the feet on the steps. The movable range variation means is configured to expand a movable range of the steps according to weight applied to the steps, whereby an additional movable range is added to the movable range, said movable range is determined by the step driving means. The movable range variation means is configured to generate resistive force when the steps are located in the additional movable range. The movable range variation means is configured to apply the resistive force to the steps such that the resistive force cancels the weight applied to the steps.

### TECHNICAL FIELD

This invention relates to exercise assisting devices being configured to give exercise to the leg of the user. Particularly, this invention relates to an exercise assisting device being configured to give a passive exercise to the leg of the user.

### BACKGROUND ART

An exercise assisting device is previously provided. The previously provided exercise assisting device is configured to provide an external force to the user's body to give the passive exercise to the user's body, whereby the previously provided exercise assisting device expand and contract the user's muscles. That is, there is no need for the user to actively exert the power of the muscle. Patent literature 1 and Patent literature 2 disclose devices. The device in the patent literatures 1 and 2 are used for giving the exercise to the user's legs. The device is used by the user in the standing posture. The device is configured to allow the user to simulate the walking exercise in order to prevent the osteoarthritis of the knee and also to give gait training.

The training device in the patent literature 1 comprises a pair of steps for bearing the left foot and the right foot of the user. In the training device of the patent literature 1, a linear reciprocatory motion in the front-back direction and right-left direction is provided to the left step and the right step. Consequently, the training device allows the user to perform a pseudo skating motion. In this training device, the left step and the right step have a phase difference between the left step and the right step. The phase difference is set in a range from 0 degree to 360 degrees when the left step and the right step are moved in the front-back direction. Similarly, the left step and the right step has a phase difference between the left step and the right step in a range from 0 degree to 360 degrees when the left step and the right step are moved in the right-left direction. In the initial term of a start of the training device, the phase difference between the left step and the right step is set as 180 degrees. Subsequently, the phase difference between the left step and the right step is varied such that the term where the left step and the right step move to the same front-back direction is increased. The left step and the right step are driven to move by the driving unit. Therefore, there is no need for the user, mounting the left foot and the right foot on the left step and the right step, to actively or voluntary exercise. That is, when the left step and the right step are moved, the left step and the right step provide the passive exercise to the legs.

The walk simulation apparatus in the patent literatures comprises a left foot support plate, a right foot support plate, and a foot support driving unit. The foot support driving unit is configured to move the left foot support plate and the right foot support plate. Furthermore, the walk simulation apparatus further comprises a means for rotating the left foot support plate and the right foot support plate forwardly and backwardly. Consequently, the heights of the feet and inclinations of the bottoms of the feet are varied according to the rotation of the left foot support plate and the right foot support plate. Furthermore, the left foot support plate and the right foot support plate in the patent literature 2 is configured to be rotatable leftward and rightward so as to vary the directions of the feet.

[Patent literature 1] Japanese patent application publication No. 2003-290386
[Patent literature 2] Japanese patent application publication No. 10-55131

### DISCLOSURE OF THE INVENTION

### Problems to be Resolved by the Invention

The training device in the patent literature 1 is configured to provide a skating action to the user by displacing “the positions of the feet” and “the position of the weight center” of the user. That is, the training device in the patent literature 1 is produced for developing the muscles of the rectus femoris muscle and the hamstrings. In order to develop the muscles of the rectus femoris muscle and the hamstrings, there is a need to expand and contract the muscles of the lower legs such as gastrocnemius muscle and soleus muscle. For expanding and contracting the muscles of the lower legs, the training device further comprises gimbals. Each one of the steps are supported by each one of the gimbals, whereby the inclination angle of each the steps are varied freely. That is, the training device is not capable of providing the stable exercise to the user having low power of the muscles of the legs when the user uses the training device. In addition, generally, the skating action applies the large load to the knees. Therefore, even if the skating action is effective for prevention of the osteoarthritis of the knee, there is a possibility that it is difficult for the user having a knee pain to use the training device.

The walk simulation apparatus in the Patent literature 2 is intended to simulate the walking action in order that the walk simulation apparatus provide “an expansion and contraction of the muscle similar to the expansion and contraction in the walking” to the muscles of the legs. Therefore, the walk simulation apparatus is preferably used for promoting a blood circulation of the vein (venous flow). However, the walk simulation apparatus applies “the load which is similar level to the load applied when the user walks” to the knee joint. Therefore, it is difficult for the user having the knee pain to use the walk simulation apparatus.

Due to this problem, the walk simulation apparatus is required to promote the expansion and contraction of the muscles of the legs for promoting the blood circulation of the vein (venous flow), while the walk simulation apparatus causes no knee pain. Such the device is strongly desired for rehabilitation of the blood circulation of the vein (venous flow). In response to this requirement, the walk simulation apparatus having steps which is movable within a small movable range is suggested. Furthermore, the walk simulation apparatus having the steps being configured to move toward a direction for reducing the load applied to the knee is also suggested. That is, the walk simulation apparatus being configured to provide only the passive exercise to the legs of the user is suggested.

However, in such the walk simulation apparatus being configured to provide the above passive exercise, the walk simulation apparatus in the above is not capable of providing further active exercise to the user even if the user wants to actively perform the exercise. It goes without saying that it is possible to respond the user's requirement by adjusting the movable range of the steps. Similarly, it is possible to respond the user's requirement by adjusting the direction where the step is moved. However in this case, there is a possibility for the user who requires only the passive exercise to use the walk simulation apparatus having a broad movable range of the steps. As a result, there is a possibility to apply the large load to the user.

This invention is achieved to solve the above problem. An object in this invention is to provide an exercise assisting device being capable of expanding the movable range of the steps according to the user's wish of increasing an amount of the exercise which is applied to the user.

### Means of Solving the Problem

In order to solve the above problem, an exercise assisting device comprises steps, a step driving means, and a movable range variation means. The steps are configured to bear feet of user, respectively. The step driving means is configured to drive the steps so as to give exercise to the feet on the steps. The movable range variation means is configured to expand a movable range of the steps according to weight applied to the steps, whereby an additional movable range is added to the movable range. The movable range is determined by the step driving means. The movable range variation means is configured to generate resistive force when the steps are located in the additional movable range. The movable range variation means is configured to apply the resistive force to the steps such that the resistive force cancels the weight applied to the steps.

It is preferred that the step driving means is configured to slide and reciprocate a left step and a right step of the within a reciprocating slide range which defines the movable range. The movable range variation means is configured to expand the reciprocating slide range of the left step and the right step. Similarly, it is also preferred that the step driving means is configured to move a front end of each the steps and a rear end of each the steps within a height range so that a height of each the front end is varied relative to each the rear end, whereby the step driving means gives a dorsi flex exercise and a plantar flex exercise to the feet on the steps. Similarly, it is also preferred that the step driving means is configured to slide and reciprocate the left step and the right step within a reciprocating slide range. The step driving means also is configured to move a front end of each the steps and a rear end of each the steps so that a height of each the front end is varied relative to each the rear end, whereby the step driving means gives a dorsi flex exercise and a plantar flex exercise to the feet on the steps. The movable range variation means is configured to expand at least one of the reciprocating slide range of the left step and the right step and the movable range of the front end of each the step and the rear end of each the step in a height direction.

It is preferred that the exercise assisting device further comprises slide units which is slidable. Each the step is attached to each the slide unit via a rotation shaft such that each the step is rotatable about the rotation shaft. The step driving means comprises a reciprocatory motion applying member and a follower member. The follower member is connected to each the steps. Each the follower member is configured to transmit a reciprocatory motion from the reciprocatory motion applying means to each said step. The follower member is configured to rotate each the step about each rotation shaft. In this case, it is more preferred that at least one of the reciprocatory motion applying means and the follower member is provided with an elastic member which is defined as the movable range variation means.

It is preferred that the exercise assisting device further comprises slide units which are slidable. Each the step is attached to each the slide unit via a rotation shaft such that each the step being rotatable about said rotation shaft. The step driving means comprises links and a reciprocatory motion applying member. Each the link is provided with a first end which is fixed to each the step. Each the link is provided with a second end which is pivotally fixed to a fixed point. The reciprocatory motion applying member is configured to rotate the link. The link is configured to reciprocate the step along a sliding direction when the link is rotated by the reciprocatory motion applying member. The link is configured to vary a height of a joint section when the link is rotated by the reciprocatory motion applying member. The joint section is created between each the step and each the link. In this case, it is more preferred that the movable range variation means is a link which has an elastic member, whereby the link has a variable length.

It is preferred that the exercise assisting device further comprises slide units which are slidable. Each the step is attached to each the slide unit via a rotation shaft such that each the step is rotatable about the rotation shaft. The step driving means comprises a reciprocatory motion applying member and a cam mechanism. The cam mechanism is connected to the steps. The cam mechanism is configured to transmit the reciprocatory motion which is generated by said reciprocatory motion applying member to the steps. The reciprocatory motion is along a sliding direction. The cam mechanism is configured to vary a height of a joint section when the cam mechanism is reciprocated by the reciprocatory motion applying member. The joint section being created between each said step and said cam mechanism.

In addition, it is preferred that the reciprocatory motion applying member is a crank mechanism which has a connecting rod. The connecting rod is provided with a elastic member, whereby the connecting rod has a variable length. The connecting rod defining said movable range variation means.

In addition, the exercise assisting device further comprises a base. The steps are disposed on an upper surface of the base. The step driving means is incorporated into the base. An entire area of the movable range is located higher than the upper surface of the base at every moment.

### EFFECT OF THE INVENTION

The exercise assisting device in this embodiment is configured to provide a passive exercise to the feet on the steps when the step driving means drives the steps. However, when the user on the steps puts the muscles of the legs to increase the weight to the steps, the movable range of the step is expanded. In addition, the resistive force is applied to the user's legs such that the resistive force cancels the weight which is caused when the user on the steps puts the muscles of the legs. Consequently, this configuration makes it possible to provide the active exercise (voluntary exercise) in addition to the passive exercise. Furthermore, it is possible to keep the safety of the exercise assisting device.

In addition, in a case where the step driving means is configured to reciprocate and slide the left step and the right step bearing the left foot and the right foot of the user and where the movable range variation means is configured to add the additional slide range to the reciprocation slide range of the step, it is possible to achieve the following two object, one is to promote the expansion and contraction of the muscles of the femoral areas and lower thigh area by the slide of the steps, and the other is to increase the load applied to the above muscles by expanding the movable range of the slide motion when the weight is applied to the steps.

In addition, in a case where the step driving means is configured to vary the height of the front end of the step relative to the rear end of the step in order to provide the dorsi flex and plantar flex exercise to the steps and where the movable range variation means is configured to expand the height range of the height of the front end of the step and the rear end of the step, it is possible to provide the dorsi flexion exercise and the plantar flex exercise to the steps. In addition, it is possible to promote the dorsi flexion and the plantar flexion when the weight applied to the step is increased, whereby the movable range of the ankle joint is increased.

In addition, it is possible to obtain the above two effect by employing the above step driving means and the above movable range variation means.

In addition, in a case where the step is attached to the slide unit, slidably supported, by the rotation shaft such that the step is rotatable about the rotation shaft, where the step driving means comprises the reciprocatory motion applying member and the follower member coupled to the steps, and where the follower member is configured to transmit the reciprocation motion which is generated by the reciprocatory motion applying member to the steps in order to rotate the step about the rotation shaft of the step, it is possible to easily achieve the slide of the step and also the rotation of the step.

In addition, in a case where the step is attached to the slide unit, slidably held, by the rotation shaft to be rotatable about the rotation shaft, where the step driving means comprises the link which is provided with a first end fixed to the step and a second end rotatably fixed to the reciprocatory motion applying member, where the reciprocatory motion applying member is configured to reciprocate the step in the sliding direction by the rotation of the link, and where the height of the joint point between the step and the link is varied, it is possible to achieve the motion of providing the slide motion, a dorsi flexion motion and a plantar flexion motion of the ankle joint, and to achieve the expansion of the movable range of the step according to the weight of the step.

Furthermore, in a case where the step is attached to the slide unit, which is slidably held, by the rotation shaft such that the step is rotatable about the rotation shaft, where the step driving means comprises the reciprocatory motion applying member and the cam mechanism being configured to transmit the reciprocation motion generated by the reciprocatory motion applying member to the steps, and where the cam mechanism is configured to vary the height of the joint point of the step according to the reciprocation motion in the sliding direction, it is possible to achieve the mechanism being configured to provide the slide motion, the dorsi flexion motion, and the plantar flexion motion to the ankle joint, easily.

In addition, in a case where the reciprocatory motion applying member is realized by the crank mechanism, where the movable range variation member is the crank mechanism with the connecting rod with elastic member such that the connecting rod has the variable length, it is possible to easily increase the movable range of the step according to the weight applied to the step.

In addition, in a case where the exercise assisting device further comprises a base which mounts the steps thereon and which incorporates the step driving means and where the entire area of the movable range of the step is located higher than the upper surface of the base, it is possible to prevent the feet from being caught by the base and the step.

### BRIEF EXPLANATION OF THE DRAWINGS

FIG. 1 shows a perspective view of an exterior of the exercise assisting device in this invention.

FIG. 2 shows a transparent planar view of the step and the step driving means of the above.

FIG. 3 shows an explanation illustration of the operation of the step driving means of the above.

FIG. 4 shows a schematic perspective view of the link of the above.

FIG. 5 shows a schematic perspective view of the connecting rod in another embodiment.

FIG. 6 A shows an explanation illustration of the operation of the step driving means in another embodiment.

FIG. 6 B shows an explanation illustration of the operation of the step driving means in another embodiment.

FIG. 6 C shows an explanation illustration of the operation of the step driving means in another embodiment.

FIG. 6 D shows an explanation illustration of the operation of the step driving means in another embodiment.

FIG. 7 shows a partially cross sectional view of the above.

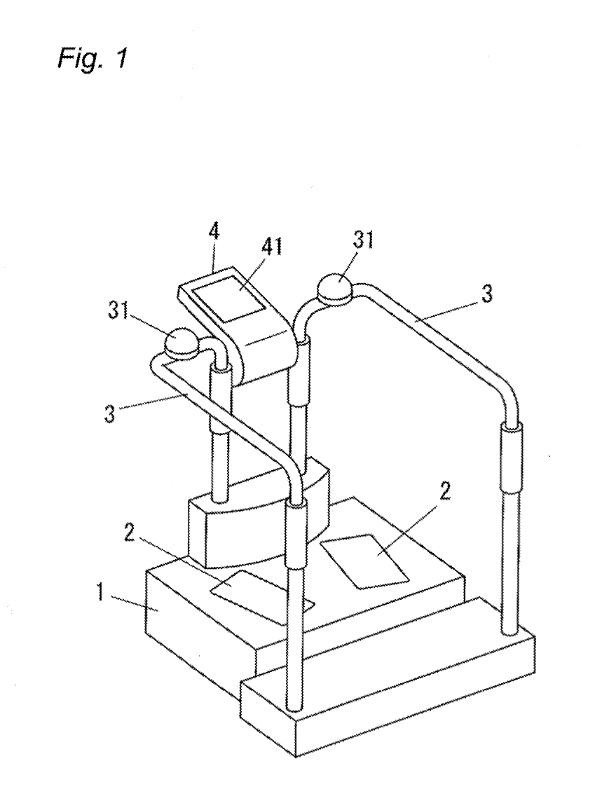

### EXPLANATION OF THE REFERENCE NUMERALS

1 base
2 step
3 handrail
4 operation panel
5 step driving means

### BEST MODE FOR CARRYING OUT THE INVENTION

Hereinafter, the invention is explained by the embodiment which is indicated by the attached drawings. The exercise assisting device in the figures comprises a left step 2, a right step 2, a base 1, handrails 3 (a left handrail 3 and a right handrail 3), an operation panel 4, and a step driving means 5. The left step 2 and the right step 2 are disposed on the base 1. The handrails 3 extend upward from the base 1. The operation panel 4 is held by the handrails 3 such that the operation panel 4 is located at a portion in the front side of the base 1 and in the upper side of the base 1. The step driving means 5 is incorporated into the base 1. The step driving means 5 is configured to operate the steps 2. When the user uses the exercise assisting device, first, the user places the left foot and the right foot on the steps 2, 2 to stand on the steps 2, 2, and holds the left handrail 3 and the right handrail 3. Subsequently, the user starts the step driving means 5. In this manner, the exercise assisting device provides the passive exercise to the user's legs by the exercise assisting device.

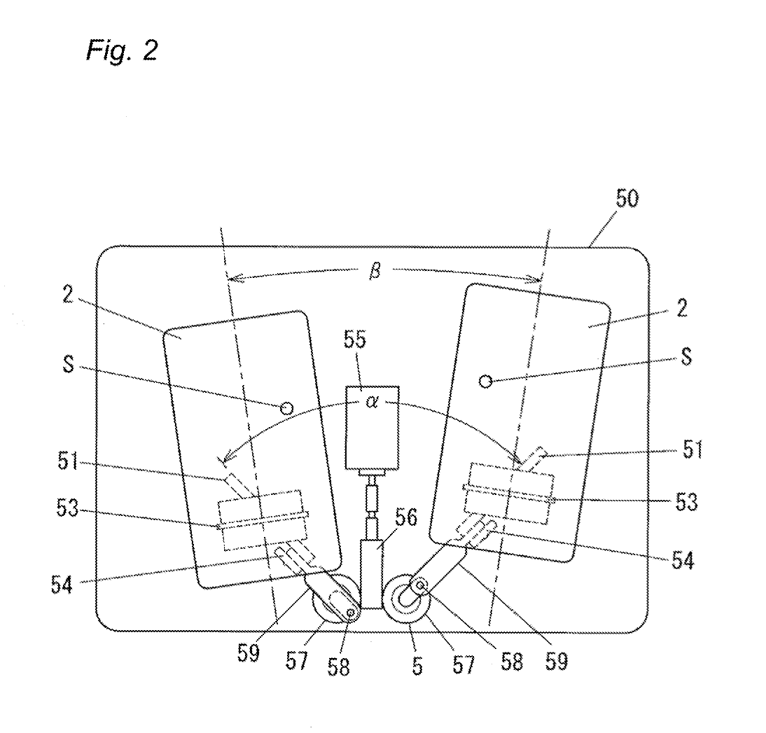

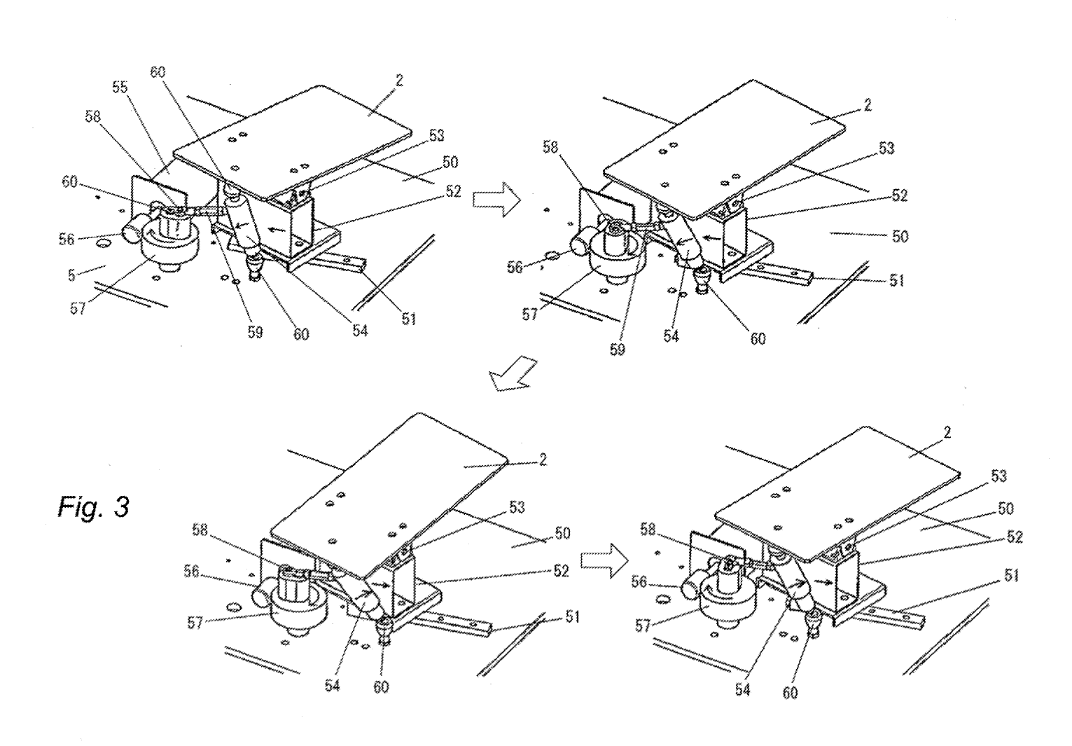

Each one of the steps 2, 2 has dimension for bearing the entire bottom of each one of the foot of the user. The steps are provided with upper surfaces which are made of material having high friction coefficient. Or, the steps are provided with the upper surfaces which are shaped so as to have the high friction coefficient. When the step driving means 5 reciprocates and slides the steps in the front-back direction and also in the left-right direction, the height of the front ends of the steps 2 is varied relative to the rear ends of the steps 2. Consequently, the step driving means repeatedly provides the plantar flexion exercise of lowering the toes of the user's feet on the steps 2, and also provides the dorsi flexion exercise of raising the toes of the user's feet on the steps 2. Each one of FIG. 2 and FIG. 3 shows a step driving means 5 being configured to move the steps as above.

The step driving means 5 shown in these figures is configured to slide the steps 2 in the front-back direction and in the left-right direction, and also varying the height of the front ends of the steps 2 relative to the rear ends of the steps 2. The base plate 50 (or the bottom plate of the base 1) is provided at its left side of the upper surface with a guide rail 51, and is provided at its right side of the upper surface with a guide rail 51. Each one of the guide rail 51 is provided at its bottom portion with a slide block 52. Each the slide blocks 52 comprises a slider member which is slidably held by each the guide rail 51. Each the slide block 52 is provided at its upper side with a rotation shaft 53. The rotation shaft 53 is configured to hold the steps 2, having plate shapes, such that the steps 2 are rotatable about the rotation shafts 53, respectively. One end (rear end) of each the step 2 and the base plate 50 are linked by the link 54. A first end of each the link and the base plate 50 is connected by a universal joint 60 which defines the coupling portion. A second end of each the link 54 and each the step 2 is also by the universal joint 60 which defines the coupling portion.

The base plate 50 mounts a drive motor 55. The drive motor 55 is located between the slide block 52 of the left side and the slide block 52 of the right side. The drive motor 55 is provided with an output shaft. The output shaft is formed with a worm 56. The base plate 50 further mounts a pair of worm wheels 57. One of the worm wheel 57 is located in the left side of the worm 56, and the other of the worm wheel 57 is located in the right side of the worm 56. Both the worm wheels 57, 57 mesh with the worm 56. Each the worm wheel 57 is provided with an eccentric shaft 58. The eccentric shaft 58 and the link 54 are connected by the connecting rod 59. The worm wheel 57 which has the eccentric shaft 58 is spaced from the link 54 in the longitudinal direction of the guide rail 51. The first end of the connecting rod 59 and the eccentric shaft 58 are also linked by the universal joint 60 which defines the coupling portion. The second end of the connecting rod 59 and the link 54 is also linked by the universal joint 60 which defines the coupling portion.

When the motor 55 rotates the eccentric shafts 58 through the worm 56 and worm wheels 57, the connecting rods 59, being cooperative with the eccentric shafts 58 to construct the crank mechanism, provides a swing motion of swinging the links 54 about the universal joint 60 attached to the base plate 50. The swing motion has motion components in directions corresponding to the longitudinal directions of the guide rails 51, 51, respectively. Each the motion components provides the reciprocatory slide motion of reciprocating and sliding each the slide blocks 52 and each the step 2 to a direction which is along the guide rail 51.

Illustrations show that the guide rail 51 of the left side is not parallel with the guide rail 51 of the right side. The guide rails 51, 51 are mounted on the base plate 50 such that the distance between the front ends of the guide rails 51, 51 is larger than the distance between the rear ends of the guide rails 51, 51. Consequently, the guide rails 51, 51 are arranged to form a V-shape. Each the slide block 52 and each the step 2 are attached to each the guide rail 51. Therefore, as each the slide block 52 and each the step 2 are moved forward, each the slide block 52 and each the step 2 are moved laterally outward.

One of the guide rail 51 is inclined at a degree with the other of the guide rail 51, whereby the guide rails 51 are arranged to form the V-shape. The angle a is equal to or more than 90 degrees to equal to or less than 135 degrees. This arrangement of the guide rails 51 is determined on the basis of the designing for preventing the large shear force from being applied to the knees. It is preferred to employ the base plates 50 which are movable with respect to the base 1. This configuration makes it possible to vary the angle a.

In addition, the swing motion of the link 54 allows the coupling portion between the link 54 and the step 2 to move upward and downward. The upward and downward motion of the coupling portion between the link 54 and the step 2 allows the step 2 to rotate about the rotation shaft 53. The step 2 becomes horizontal when the step 2 is located on the middle portion of the stroke of the slide motion of the step. The rear end of the step 2 which is connected to the link 54 is raised when the step 2 is located on a first end of the stroke. The rear end of the step which is connected to the link 54 is lowered when the step 2 is located on a second end, which is located in an opposite relation to the first end, of the stroke.

In addition, the step 2 is rotated about the rotation shaft. Therefore, as the step 2 moves forward, the front end of the step is lowered. In addition, as the step 2 moves rearward, the rear end of the step 2 is lowered.

In addition, as is obvious from FIG. 2, the rotation shaft 53 which is defined as a rotation center of the step 2 extends along the direction perpendicular to the longitudinal direction of the step 2. In addition, the rotation shaft 53 which is defined as the rotation center of the step 2 is located on a rear side from the longitudinal center of the step 2. Furthermore, an axial direction of the rotation shaft 53 is not perpendicular to the longitudinal direction of the guide rail 51, whereby the front end (toe side) of the step 2 is located in an inside portion from the guide rail 51.

The steps 2, 2 are arranged such that the distance between the front ends of the steps 2 is greater than the rear ends of the steps 2. The steps 2, 2 are arranged to make angle of B. The angle B is equal to 10 to 30 degrees. Therefore, the user is able to place the user's feet on the steps 2, 2 while the user keeps the user's muscles in a relaxed state.

In addition, the eccentric shaft 58 of the one of the worm wheel 57, which meshes with the worm 56, is displaced from the eccentric shaft 58 of the other of the worm wheel 57 which meshes with the worm 56. The left step 2 and the right step 2 is driven to move by the step driving means such that when the right step 2 moves forward, the left step 2 moves rearward. The left step 2 and the right step 2 is driven to move by the step driving means such that when the right step 2 moves rearward, the left step 2 moves forward. That is, the left step 2 is moved in a phase which is opposite of the phase of the right step 2. The motions of the left step 2 and the right step 2 are realized by the power which is divided by the two worm wheels 57, 57, which meshes with the worm 56. Therefore, the motion of the right step 2 is in synchronization with the motion of the left step 2.

When the user uses the above mentioned exercise assisting device, first, the user places the user's left foot and the right foot on the left step 2 and the right step 2, respectively, and holds the hand rail 3. Subsequently, the user turns on the operation switch on the operation panel 4. Consequently, the step driving means 5 is started. When the step driving means 5 is started, the left step 2 and the right step 2 is moved frontward-rearward and leftward-rightward such that phase of the motion of the left step 2 is opposite to the phase of the motion of the right step 2. In addition, when each the step 2 moves forward, the front end of each the step 2 moves downward. When each the step 2 moves rearward, the rear end of each the step 2 moves downward.

Consequently, when the user places the user's feet on the steps 2, the user's feet is moved frontward-rearward and leftward-rightward according to the motion of the steps 2. In addition, the rotation of the step 2 provides the dorsi flextion motion exercise and the plantar flex motion exercise to each the ankle joint. When the steps are moved, the phase of the motion of the left step 2 is shifted from the phase of the motion of the right step 2 by 180 degrees. Therefore, it is possible to reduce the displacement of the weight center of the user, on the steps 2, in the front-rear direction. Therefore, even if the user having low balance ability uses the exercise assisting device, there is little possibility of breaking the balance of the user according to the movement caused by the step 2.

In addition, the one of the steps 2 is moved forward-rearward and leftward-rightward in the phase which is opposite to the phase which is caused when the other of the steps 2 is moved forward-rearward and leftward-rightward, whereby the variation of the feet position is caused. The variation of the feet position is similar to the walking exercise. Therefore, the muscles of at least the lower legs is expanded and contracted similar to the walking exercise. In addition, when the step 2 is located in the rear end position in the forward-rearward motion, the position of foot is located at rear position than the weight center of the user. Therefore, when the step 2 is located in the rear end position in the forward-rearward motion, it is possible to tense “the muscles of the rear side of the femoral muscles” and “the muscles of the buttocks”.

In general walking exercise, each the foot is moved forward and rearward, mainly. However, it is preferred to move each the foot leftward-rightward in addition to the forward-rearward. In this case, it is possible to twist the body trunk, compared with the case where the foot is moved only forward and rearward or where the foot is moved only leftward and rightward. The twist of the body trunk provides the stimulation to inward organs. Furthermore, the twist of the body trunk breaks the balance of the user in multiple directions positively. The breaking of the balance of the user in the multiple directions provides the stimulations to the muscles of the lower legs and the femoral areas (adducent muscles, rectus femoris, medial great muscles, lateral great muscles, biceps femoris, semitandinosus muscles, semimembranosus). Although the stimulation to the muscles of the above is low load and passive exercise, an amount of the sugar which is consumed by the muscles is increased. As a result, the improvement of the type 2 diabetes is promised.

In addition, when the dorsi flex exercise is provided to each the foot, the Achilles tendon is stretched. Therefore, the movable range of the ankle is expanded. Furthermore, when the plantar flex exercise is provided to each the foot, the load is applied to the each the toes. Therefore, it is possible to lessen the hallux valgus. In addition, when the dorsi flex exercise and the plantar flex exercise are alternately provided to each the foot, expansion and contraction of the muscles of the lower legs such as gastrocnemius and soleus muscleare are caused. The expansion and the contraction of the muscles of the lower legs increase the venous flow of the legs. As a result, it is possible to relieve the swelling of the legs.

As is obvious from the configuration of the step driving means 5, the phase difference in the forward-rearward and leftward-rightward between left step 2 and the right step 2 is determined by the positions of the eccentric shafts of the worm wheels 57. That is, the phase difference in the forward-rearward and leftward-rightward between left step 2 and the right step 2 is determined by meshing positions where each the worm wheels 57 meshes with the worm 56. Therefore, desirable phase difference is set by varying the meshing position. That is to say, it is possible to move the left step 2 in the phase which is equal to the phase of the right step 2, easily. When the left step 2 is moved in the phase which is equal to the phase of the right step 2, the weight center of the user is moved forward-rearward. Therefore, it is possible to provide not only the exercise of the muscles of the legs but also the muscles of the lower back which is required for keeping the balance to the user.

The user is able to use the exercise assisting device in order to perform the passive exercise while the user holds the hand rails 3. Therefore, even if there is a possibility of breaking the balance of the user, it is possible to prevent the falling of the user from the exercise assisting device. However, in order to improve the safety when the user loses the balance, the hand rails 3 are provided with emergency stop buttons 31. Each one of the emergency stop buttons 31 is configured to stop the operation of the step driving means 5. The emergency stop button 31 is easily pushed by the hand holding the hand rail 3 when the some sort of the accident is occurred.

It is also preferred that the step 2 is provided with a weight detection switch S. The weight detection switch 6 is realized by a pressure sensor. In this case, the step driving means 5 is configured to stop the step 2 when the weight detection switch 5 detects no weight in a condition where the step driving means 5 drives the steps 2. Consequently, it is possible to automatically stop the step driving means 5 when the foot is apart from the step 2 due to the balance loss.

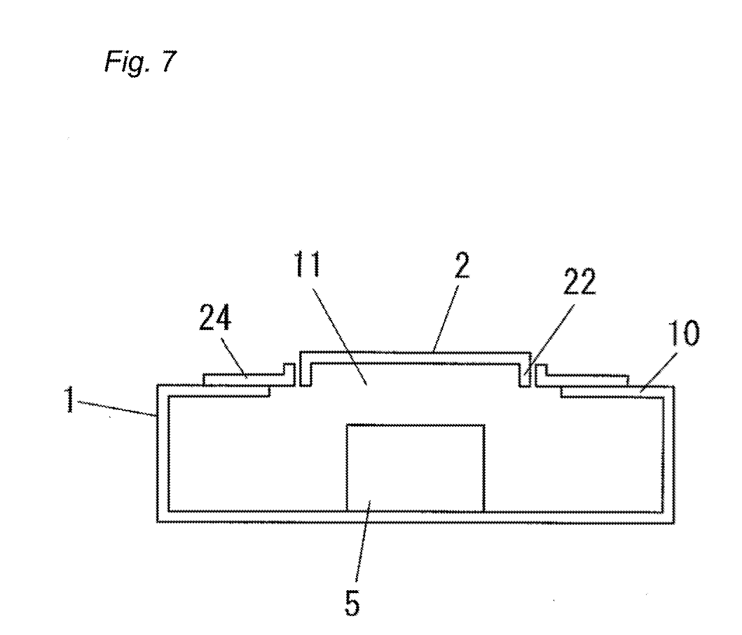

The base 1 which incorporates the step driving means 5 is, as is obvious from FIG. 7, provided with a top panel 10. The top panel is formed with an opening 11. The steps 2 are arranged such that the steps 2 are located at an upper side of the top panel 10. The step 2 is linked to the step driving means 5 in the opening 11. Furthermore, an entire area of the rotation range, being defined by the rotation axis 53 about which the step 2 rotates, is located higher than the top plate 10 at every moment. The rotation range includes the additional movable range which is explained later.

Consequently, even if the foot on the step 2 protrudes outside the upper surface of the step 2, it is possible to prevent the foot from being caught between the top plate 10 and the base 1. In addition, as shown in FIG. 7, each the step 2 is provided at its circumference with a skirt 22. The base 1 is provided with a slide cover 24. The slide cover 24 surrounds the step 2. The side cover 24 is configured to slide relative to the top plate 10 when the step 2 moves forward-rearward and leftward-rightward. Consequently, it is possible to safely use the exercise assisting device. It is also preferred to employ the foot holding means for holding the foot to the step 2. The foot holding means is exemplified by the strap for holding the foot.

In the driving of the step 2 by the step driving means 5, the eccentric amount of the eccentric shaft 58 of the reciprocatory motion applying means realized by the crank mechanism including the eccentric shaft 58 and the connecting rod 59 is determined. Similarly, the length of the link 54 is determined. The slide range of the step 2 is determined. The rotation range (rotation angle) which centers the rotation shaft 53 of the step 53 is determined. When the step is strongly treaded according to the rotation of the step 2, the slide range and also the rotation range of the step 2 are expanded. Furthermore, when the slide range and also the rotation range of the step 2 is expanded, the resistive force is generated and applied to each the user's foot.

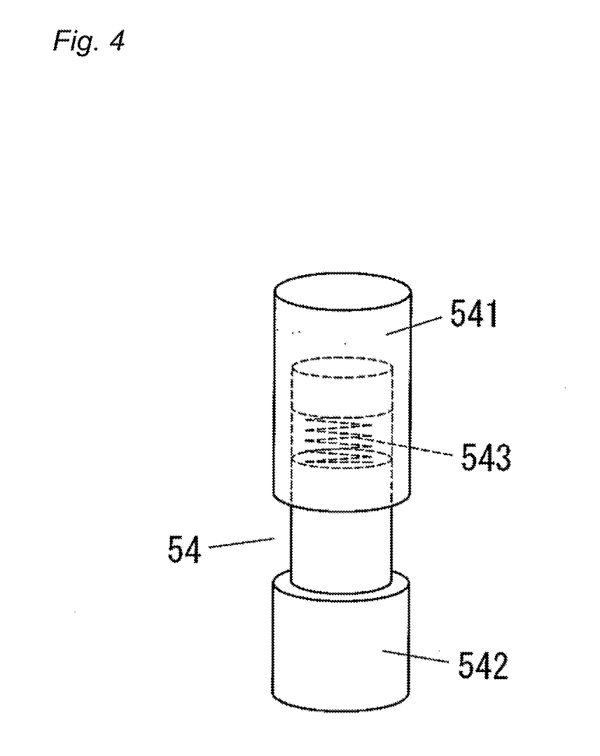

This configuration is realized by the link 54 shown in FIG. 4. That is to say, the link 54 comprises a member 541, a member 542, and a helical extension spring 543 which is an elastic body. The member 542 is stretchably attached to the member 542 through the helical extension spring 543.

In a normal condition, the link 54 has a shortest condition due to the bias of the helical extension spring. When the weight applied to the front end of the step is increased by the user in a condition where the step driving means 5 lowers the front end of the step 2, the link 54 is extended against the spring bias of the helical coil spring 543. That is to say, the length of the link 54 is increased. As a result, the rotation range of the step 2 is increased. Furthermore, the slide range of the step 2 is also increased. In addition, the bias of the helical extension spring 5 is applied to the step 2. Therefore, the foot on the step 2 receives the resistive force which is generated by the helical extension spring.

Therefore, as for user, when the user strongly treads the step 2, the movable range of the foot in the slide motion is increased. Similarly, the movable range of the dorsi flexion motion and the plantar flexion motion is also increased. Furthermore, the strong resistive force is applied to the foot in synchronous with the above. That is to say, it is possible to shift to “the active exercise of the foot which is actively moved by the user's will” from “the passive exercise of the foot which is passively moved by the motion of the step 2”. Furthermore, when the user performs the active exercise, the movable range of the foot is increased. In addition, the strong resistive force is applied to the foot. Therefore, it is possible to obtain the high exercise effect.

In addition, the additional movable range and the resistive force are determined according to the force applied to the step 2 by the user. Therefore, it is possible to prevent the excess increase of the additional movable range and an excess increase of the resistive force.

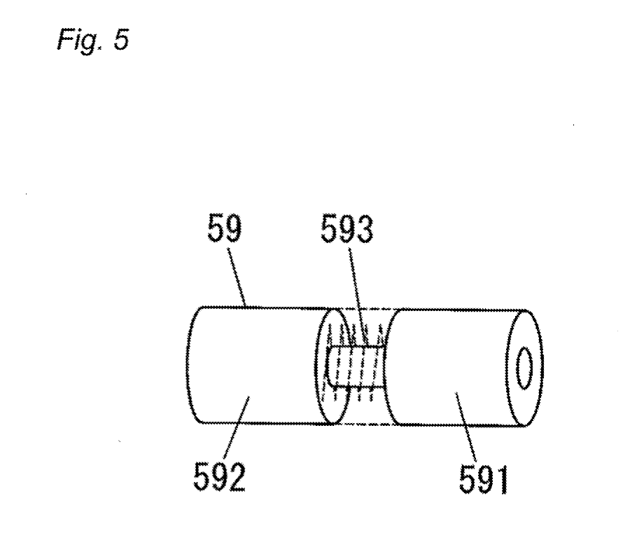

In the above embodiment, a movable range variation means is realized by the link 54. The link 54 incorporates the helical extension spring 543. The link 54 is configured to expand the movable range of the steps according to the weight applied to the steps. The link 54 is configured to generate the resistive force which cancels the weight in the additional movable range. However, it is possible employ the crank mechanism comprising the connecting rod 59 having configurations same as the configurations of the link 54. That is to say, as shown in FIG. 5, it is possible to employ the connecting rod 59 having a member 591 and a member 592 which is connected by the helical extension spring 593. Also in this case, in the configurations in the Figures, it is possible to add the additional slide range to the slide range of the step according to the length of the connecting rod 59. In addition, it is possible to add the additional rotation range to the rotation range in a direction of lowering the front end of the step 2.

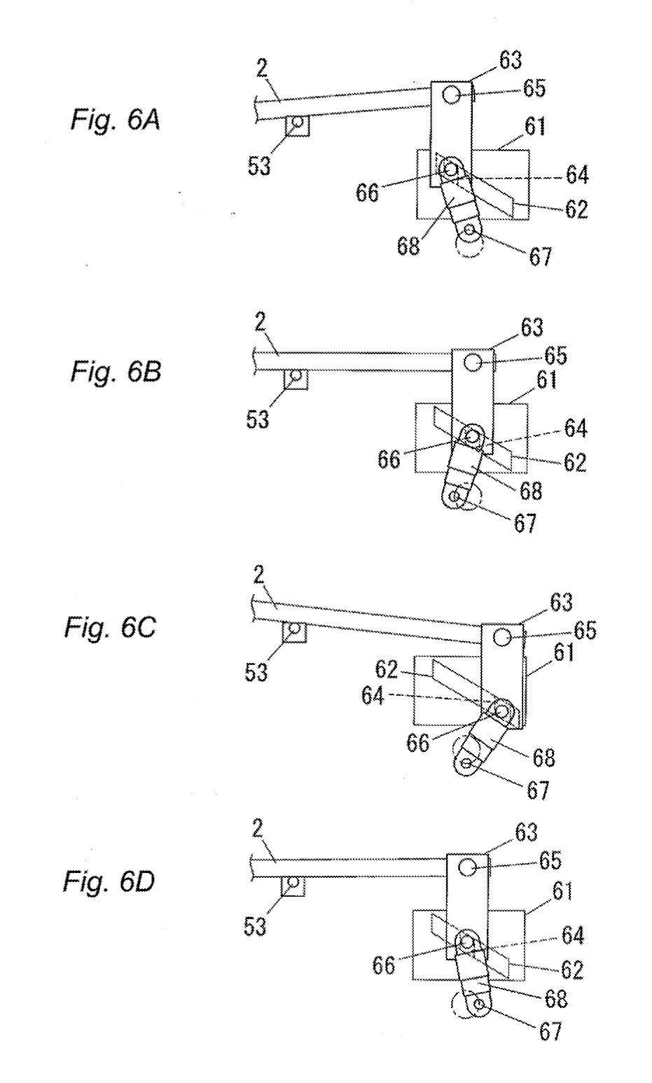

FIG. 6 shows another embodiment of the step driving means 5. In this embodiment, the step driving means 5 comprises a cam plate 61 and a coupling plate 63 instead of the link 54 of the above embodiment. The cam plate 61 is provided with a grooved cam 62. The grooved cam 62 extends downward from the upper side and forward from the rear side.

The coupling plate 63 comprises a cam follower 64. The cam follower 64 is configured to slidably moves along the cam 62 defined by an oblique groove. The cam follower 64 is shaped to have a rectangular shape. The coupling plate 63 is provided with a shaft 65 which is rotatable. The shaft 65 is connected to the rear end of the step 2. The step 2 is supported by the slide block 52 through a rotation shaft 53 to be rotatable, similar to the above embodiment. In addition, the connecting rod 68 is provided with a first end which is coupled to the eccentric shaft 67 which is rotated. The connecting rod 68 is provided with a second end, opposite to the first end, which is coupled to the shaft 66.

With this configuration, when the eccentric shaft 67, which is located in the lower side of the coupling plate 63, is rotated, the connecting rod 68 allows the coupling plate 63 to move along the cam 62. The cam follower 64 has the rectangular shape, and is fixed to the coupling plate 63. Therefore, when the connecting rod 68 allows the coupling plate 63 to move along the cam 62, the coupling plate 63 is moved forward-rearward and upward-downward while the coupling plate 63 keeps the state shown in the Figure.

Consequently, when the rear end side which is defined by the joint section between the connection plate 63 and the step 2 is moved in the vertical direction, the step is also moved forward-rearward. When the step 2 moves forward, the rear end of the step 2 is raised, whereby the front end (toe side) of the step 2 is lowered. When the step 2 moves rearward, the rear end of the step 2 is lowered, whereby the front end (toe side) of the step 2 is raised. It should be noted that it is not important for the slide direction of the step 2 to have a perpendicular relation with respect to the axial direction of the rotation shaft 53.

Similar to the above embodiment, it is possible to employ the crank mechanism having the eccentric shaft 58 and the connecting rod 68 shown in FIG. 5. With this configuration, it is possible to increase the slide range of the step 2. Furthermore, this configuration makes it possible for the cam 62 to have the length according to the additional slide range. In addition, it is preferred that the cam 62 has the additional range for increasing the rotation range of the step 2. Consequently, it is possible to add the additional rotation range to the rotation range.

In the embodiment using the link 54 shown in the first, it is possible to connect connecting rod 59 to the slide block 52, instead of the link 54. In this case, one end of the link 54 is fixed to the base plate 50 through the shaft such that the link 54 rotates in a direction parallel to “the slide direction of the step 2 “which is defined by the guide rail. The base plate 50 and the step 2 are connected by the link 54. Therefore, when the slide block 52 and also the step 2 slides, the link 54 rotates about its one end being located in a side of the base plate 50. Therefore, when the height of the connection portion between the link 54 and the step 2 is varied, the step 2 is rotated. However, in this embodiment, the additional movable range of the step 2 is added to only the slide range when the connecting rod 59 shown in FIG. 5 is employed. In contrast, the additional movable range of the step 2 is added to the rotation range when the link 54 shown in FIG. 5 is employed.

In the above explanation, the movable range variation means is realized by the elastic member, especially, spring element. Consequently, the movable range variation means is configured to expand the step's movable range which is determined by the step driving means 5 when the weight applied to the step 2 is increased. In addition, the movable range variation means is configured to generate the resistive force in the additional range. However, the movable range variation means is not limited to the elastic member. That is to say, it is possible to employ configurations which are configured to achieve the above operations.

1. An exercise assisting device comprising:
steps being configured to bear feet of user, respectively,
a step driving means being configured to drive said steps so as to give exercise to the feet on the steps,
a movable range variation means being configured to expand a movable range of the steps according to weight applied to the steps, whereby an additional movable range is added to the movable range, said movable range is determined by the step driving means,
said movable range variation means being configured to generate resistive force when the steps are located in the additional movable range,
said movable range variation means being configured to apply the resistive force to steps such that the resistive force cancels the weight applied to the steps.

2. The exercise assisting device as set forth in claim 1, wherein
said steps are defined by a left step and a right step for bearing a left foot and a right foot of the user, respectively,
said step driving means being configured to slide and reciprocate said left step and said right step within a reciprocating slide range, and
said movable range variation means being configured to expand the reciprocating slide range of said left step and said right step.

3. The exercise assisting device as set forth in claim 1, wherein
said step driving means is configured to move a front end of each said steps and a rear end of each said steps so that a height of each said front end is varied relative to each said rear end, whereby said step driving means gives a dorsiflex exercise and a plantarflex exercise to the feet on the steps,
said movable range variation means being configured to expand the movable range of said front end of each said step and said rear end of each said step in a height direction.

4. The exercise assisting device as set forth in claim 1, wherein
said steps are defined by a left step and a right step for bearing a left foot and a right foot, respectively,
said step driving means being configured to slide and reciprocate said left step and said right step within a reciprocating slide range,
said step driving means also being configured to move a front end of each said stops and a rear end of each said steps so that a height of each said front end is varied relative to each said rear end, whereby said step driving means gives a dorsi flex exercise and a plantar flex exercise to the feet on the steps,
said movable range variation means being configured to expand at least one of the reciprocating slide range of said left step and said right step and the movable range of said front end of each said step and said rear end of each said stop in a height direction.

5. The exercise assisting device as set forth in claim 1, wherein
said exercise assisting device further comprises slide units which is slidable,
each said step being attached to each said slide unit via a rotation shaft such that each said step being rotatable about said rotation shaft,
said step driving means comprises a reciprocatory motion applying member and a follower member, said follower member being connected to each said steps,
each said follower member being configured to transmit a reciprocatory motion from the reciprocatory motion applying means to each said step, and
said follower member being configured to rotate each said step about each said rotation shaft.

6. The exercise assisting device as set forth in claim 5, wherein
at least one of said reciprocatory motion applying means and said follower member is provided with an elastic member which is defined as said movable range variation means.

7. The exercise assisting device as set forth in claim 4, wherein
said exercise assisting device further comprises slide units which are slidable,
each said step being attached to each said slide unit via a rotation shalt such that each said step being rotatable about said rotation shaft,
said step driving means comprising links and a reciprocatory motion applying member,
each said link is provided with a first end which is fixed to each said step,
each said link is provided with a second end which is pivotally fixed to a fixed point,
said reciprocatory motion applying member being configured to rotate the link,
said link being configured to reciprocate said step along a sliding direction when the link is rotated by the reciprocatory motion applying member, and
said link being configured to vary a height of a joint section when the link is rotated by the reciprocatory motion applying member,
said joint section being created between each said step and each said link.

8. The exercise assisting device as set forth in claim 4, wherein
said exercise assisting device further comprises slide units which are slidable,
each said step being attached to each said slide unit via a rotation shaft such that each said step being rotatable about said rotation shaft,
said step driving means comprising a reciprocatory motion applying member and a cam mechanism,
said cam mechanism being connected to the steps,
said cam mechanism being configured to transmit the reciprocatory motion which is generated by said reciprocatory motion applying member to the steps, said reciprocatory motion is along a sliding direction,
said cam mechanism being configured to vary a height of a joint section when the cam mechanism is reciprocated by the reciprocatory motion applying member,
said joint section being created between each said step and said cam mechanism.

9. The exercise assisting device as set forth in claim 7, wherein
said movable range variation means is a link which has an elastic member, whereby the link has a variable length.

10. The exercise assisting device as set forth in claim 5, wherein
said reciprocatory motion applying member is a crank mechanism which has a connecting rod,
said connecting rod is provided with a elastic member, whereby the connecting rod has a variable length,
said connecting rod defining said movable range variation means.

11. The exercise assisting device as set forth in claim 6, wherein
said elastic member is a spring element.

12. The exercise assisting device as set forth in claim 1, wherein
said exercise assisting device further comprises a base,
said steps being disposed on an upper surface of said base,
said step driving means being incorporated into said base,
an entire area of said movable range being located higher than said upper surface of said base at every moment.
